(19) United States
(12) Patent Application Publication
(10) Pub. No.: US 2026/0128579 A1
(43) Pub. Date: May 7, 2026

(54) CONNECTIONS TO SUBSEA ELECTRICAL EQUIPMENT

(71) Applicant: SUBSEA 7 NORWAY AS, Stavanger (NO)

(72) Inventors: Øivind STANGELAND, Sandnes (NO); Julien MANACH, Aberdeen (GB)

(21) Appl. No.: 19/121,825

(22) PCT Filed: Oct. 20, 2023
(86) PCT No.: PCT/EP2023/079384

§ 371 Date: Apr. 17, 2025

(30) Foreign Application Priority Data
Oct. 21, 2022 (GB) 2215640.0

(51) Int. Cl. H02G 11/00; H02G 3/04; H02G 9/00

(52) U.S. Cl. CPC H02G 11/00; H02G 3/0456; H02G 9/00

(57) ABSTRACT

A pivoting cable connection for a subsea equipment unit comprises a tubular cable guide supported by the unit, extending along and around a pivot axis. A cable extending through the connection comprises an intermediate section extending along or beside the pivot axis within the cable guide and an outboard section, pivotable about the pivot axis, that extends away from the pivot axis in a direction transverse to the pivot axis. When installing or retrieving the unit onto or from the seabed, pivotal movement of the outboard section of the cable relative to the unit is accommodated by torsional deformation of the intermediate section of the cable. By allowing the cable to pivot above and below the pivot axis, the connection enables the unit to be lowered from a vessel that also pays out and lays the cable. Preliminarily, the cable can be coupled to the unit aboard the same vessel.

This invention relates to the challenges of connecting elongate flexible conductors or cables to subsea electrical equipment. Examples of such equipment include subsea transformers, pumps, compressors, variable-speed drives and switchgear, including any supporting or surrounding frames or structures. Subsea cables are used to convey electrical power to or from such equipment and may also be used for other purposes, for example to convey data signals.

Some subsea cables are known in the art as umbilicals. Umbilicals typically comprise two or more conductors or other elongate elements such as fibre optics or fluid conduits, in addition to protective and reinforcing elements. Some subsea cables or smaller umbilicals are known in the art as flying leads. For simplicity, references in this specification to cables will encompass umbilicals and other flexible conductors such as flying leads.

For connection to a preinstalled subsea structure, a cable may comprise a termination head or termination assembly including a connection hub to be coupled to a complementary destination hub of the subsea structure. Only one direction of connection is possible depending on the common axial orientation of the hubs, for example a horizontal or vertical direction.

Sometimes, an articulated lifting yoke is mounted on a cable termination as exemplified by U.S. Pat. No. 9,206,652 and WO 2019/179986. The yoke is independent of and additional to the cable and is dedicated to installation. Consequently, the yoke constitutes a bulky piece of equipment that is, wastefully, useless after installation.

Lifting yoke systems like those disclosed in U.S. Pat. No. 9,206,652 and WO 2019/179986 are not practical where the connection hub of a cable must itself be tilted relative to, or into axial alignment with, the destination hub. To the contrary, a lifting yoke is designed to compensate for tilting so that the connection hub will remain in a particular desired orientation, such as on a horizontal axis. It therefore remains a challenge to tilt a connection hub into a different orientation, such as onto a non-horizontal axis, while lifting the head. Indeed, heavy bend stiffeners are typically mounted on the cable to mitigate potential bending moments if this occurs.

WO 2018/127552 introduces a mechanical pivot in a termination head for a flying lead cable. A connection hub of the termination head can be moved horizontally for connection to a destination hub while the remainder of the termination head is tilted at an angle to the horizontal due to constraints of lifting. For this purpose, a free section of flexible cable runs around the pivot between the connection hub and the remainder of the termination head, which is tilted. That free section of cable must bend sharply across the pivot, which risks damage to the cable through bending stresses and would be impractical for cables with large diameter or stiff construction and hence a large minimum bend radius.

Prior art like WO 2018/127552 is unsuitable when a termination head is coupled to heavy electrical equipment, such as a subsea transformer, without an intermediate connection. Maintaining horizontality of the electrical equipment and the termination head is the most important constraint.

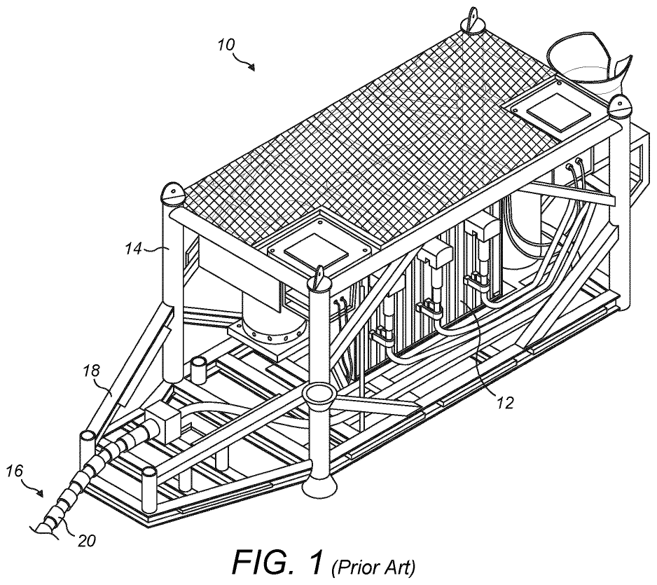

In this respect, the challenges addressed by the invention are best understood by explaining conventional installation techniques used for subsea transformers as an example of subsea electrical equipment. A typical subsea transformer unit 10 is shown in FIG. 1, comprising transformer equipment 12 fixed within a supporting and surrounding frame 14. An umbilical cable 16 connects to the unit 10 and is fixed rigidly to an outrigger 18 at one end of the frame 12, either penetrating or extending through the outrigger 18 or being connected to a connector supported by the outrigger 18. The cable 16 is surrounded with a bend restrictor 20 extending outboard of the outrigger 18.

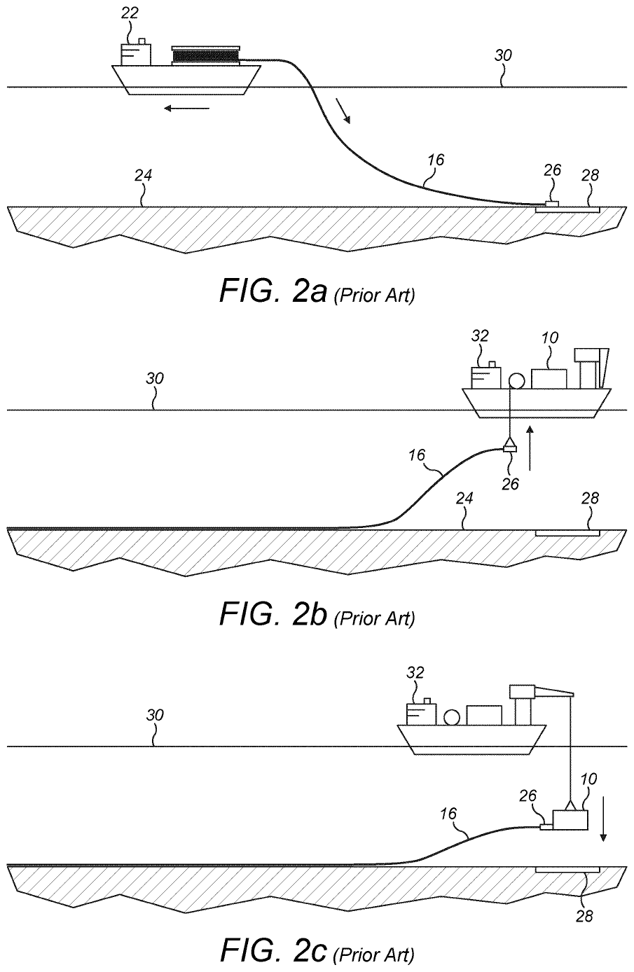

Items of subsea equipment like the unit 10 shown in FIG. 1 are large and heavy loads that must be lifted horizontally and remain horizontal while being lowered from a surface vessel to the seabed or while being recovered from the seabed to the surface. A cable 16 connecting to the transformer equipment 12 via the frame 14 must therefore also be kept close to horizontal where it adjoins the frame 14. This complicates and prolongs conventional installation techniques as illustrated in FIGS. 2a to 4b, greatly increasing cost and requiring a lengthy weather window to be available.

FIGS. 2a to 2c show a first installation technique that involves two operations to be performed by one or two vessels. Firstly, as shown in FIG. 2a, a first vessel 22 lays a power cable 16 on the seabed 24 with a connector 26 at its free end placed on or adjacent to a subsea foundation 28. Subsequently, as shown in FIG. 2b, the connector 26 at the free end of the cable 16 is retrieved to the surface 30 by a second vessel 32 that carries the unit 10. Via the connector 26, the cable 16 is connected to the unit 10 aboard the vessel 32. Finally, as shown in FIG. 2c, the unit 10 with the cable 16 connected to it is lifted from the vessel 32 and lowered from the surface 30 down to the foundation 28 on the seabed 24.

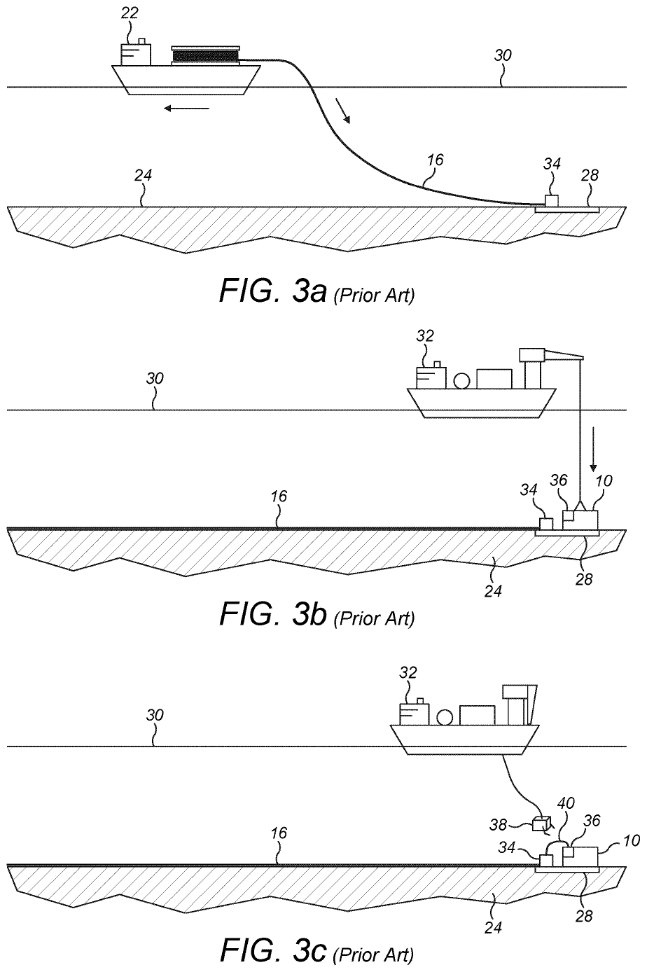

FIGS. 3a to 3c show a second installation technique that involves three operations to be performed by one, two or even three vessels. Again, a power cable 16 is laid on the seabed 24 by a first vessel 22 as shown in FIG. 3a but in this case the cable 16 is fitted with an umbilical termination head (UTH) 34 placed on a foundation 28. Next, as shown in FIG. 3b, the unit 10 is lifted from a second vessel 32 and lowered down to the foundation 28 beside the UTH 34. In this case, the unit 10 includes an umbilical termination assembly (UTA) 36. Finally, as shown in FIG. 3c, an ROV 38 uses flying leads 40 to connect the UTH 34 of the cable 16 to the UTA 36 of the unit 10.

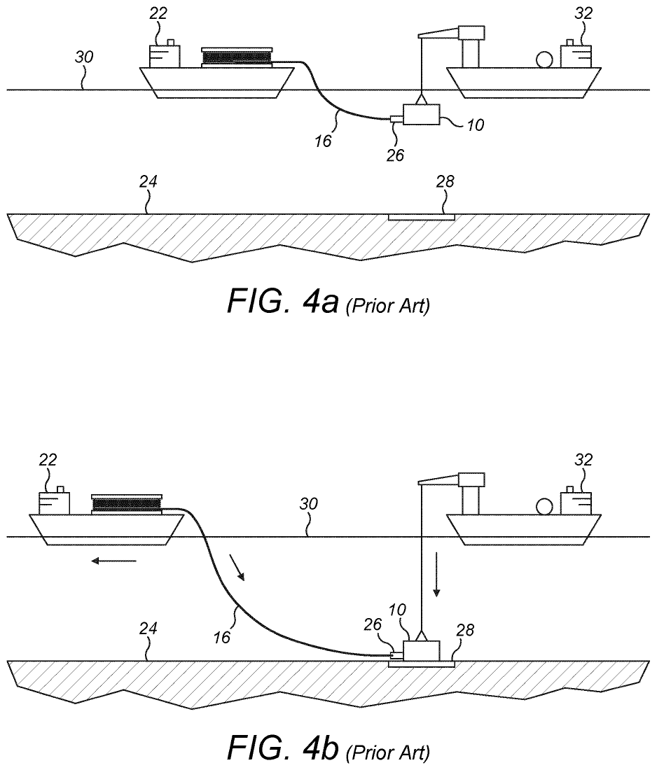

FIGS. 4a and 4b shows a third installation technique in which one operation is performed simultaneously by two vessels 22, 32. Here, a unit 10 with the cable 16 already connected to it above the surface 30 is shown in FIG. 4a being lowered from a second vessel 32 down to a foundation 28 on the seabed 24. Meanwhile, or subsequently, a first vessel 22 lays the cable 16 away from the unit 10 as shown in FIG. 4b.

Other documents considered to be of background relevance are EP 3444428; WO 2020/136378; US 2015/167268; FR 2429955; U.S. Pat. No. 3,922,870; US 2015/176340; EP 2511996; US 2016/281453; and EP 3000716.

Against this background, the invention provides a pivoting cable connection for a subsea equipment unit. The connection comprises: a cable guide supported by the unit and extending along and around a pivot axis that is preferably substantially horizontal; and a cable extending on a cable path through the connection. The cable comprises:
an intermediate section at least partially within the cable guide, extending along or beside the pivot axis; and an outboard section, pivotable about the pivot axis, extending away from the pivot axis in a direction transverse to the pivot axis.

The cable guide may form part of a yoke that is pivotable about the pivot axis and that supports the outboard section of the cable at a location offset laterally from the pivot axis. The cable guide is preferably tubular and could be a gutter or a groove, for example on the yoke.

An anchor formation may fix the outboard section of the cable relative to the cable guide. The outboard section of the cable may be supported by at least one arm cantilevered from the cable guide.

The outboard section of the cable may curve away from the pivot axis contained within a portion of the cable guide that correspondingly curves away from the pivot axis. More generally, the outboard section of the cable may curve away from the pivot axis onto an exit axis that is substantially orthogonal to the pivot axis. The outboard section of the cable may, for example, be aligned with the subsea equipment unit. In either case, the outboard section of the cable suitably curves away from the pivot axis in a plane that contains the pivot axis.

The intermediate section of the cable may be disposed between the outboard section of the cable and an inboard section of the cable that extends transversely relative to the pivot axis away from the pivot axis and toward equipment of the unit. The inboard section of the cable may be in substantially fixed relation to the unit.

The inboard section of the cable may be received in a duct that communicates with the cable guide. For example, the duct and the inboard section of the cable may together curve away from the pivot axis.

A swivel acting between the duct and the cable guide suitably permits pivotal movement of the cable guide relative to the duct about the pivot axis. Conveniently, the swivel may surround an aperture in a support, such as an upright flange, that joins the connection to the subsea equipment unit. In that case, the duct suitably communicates with the cable guide through the aperture.

Elegantly, the intermediate section of the cable may be arranged to deform in torsion as the outboard section pivots about the pivot axis. Nevertheless, the intermediate section may comprise two or more generally parallel strands that are arranged to bend along their length independently as the intermediate section deforms in torsion as a whole.

The connection may be joined to the subsea equipment unit by a pair of supports such as flanges that are mutually spaced along the pivot axis. In that case, the cable may curve away from the pivot axis between the supports of the pair and/or outboard of at least one of the supports of the pair.

The inventive concept embraces a subsea equipment unit comprising the connection of the invention, and further extends to a corresponding method of installing or retrieving a subsea equipment unit onto or from the seabed. That method comprises: causing an outboard section of a cable connected to the unit to pivot relative to the unit about a pivot axis, which axis is preferably substantially horizontal; and accommodating that pivotal movement by torsional deformation of an intermediate section of the cable that is guided to extend along or beside the pivot axis. The outboard section of the cable extends away from the pivot axis in a direction transverse to the pivot axis.

The outboard section of the cable may be held in a substantially vertical orientation, above the pivot axis, when lowering the unit toward the seabed during installation. Then, the outboard section of the cable may be pivoted into a substantially horizontal or below-horizontal orientation after landing the unit on the seabed. For example, the outboard section of the cable may be pivoted into that orientation by laying the cable on the seabed in a lay direction extending away from the unit.

On lifting the unit from the seabed, the outboard section of the cable may be allowed to drop into a substantially vertical orientation, below the pivot axis.

The outboard section of the cable may be locked against pivotal movement after installing the unit or may be unlocked to permit pivotal movement before retrieving the unit.

Efficiently, the unit can be installed when suspended from a vessel that also pays out the cable. The same vessel can be used to lay the cable after landing the unit on the seabed. Preliminarily, the cable can be coupled to the unit aboard the same vessel.

Thus, the invention adapts subsea structures for electrical equipment and associated installation methods to reduce installation time, ease retrieval and minimise complexity. Specifically, the invention improves arrangements for connecting a subsea power cable to subsea electrical equipment by adding a power cable pivot support on the equipment structure that offers flexibility in managing a cable connected to the equipment.

The invention enables installation without requiring the cable and the electrical equipment to be installed on the seabed in separate operations and then connected together. Thus, installation of subsea equipment together with its power supply cable can be done quickly with a single vessel in a single operation, in contrast to known alternatives that may require two or more vessels and/or more complex and time-consuming operations. Potentially, the invention also removes the need for wet-mate connectors.

The invention provides additional degrees of freedom for connection of a cable termination to subsea electrical equipment. More specifically, the invention provides a connection for a cable, the connection comprising a pivoting yoke that is pivotable relative to the structure about a pivot axis. The cable is coupled to the yoke and runs through or extends along or beside the pivot axis of the yoke in the direction of the pivot axis. The inventive concept extends to subsea electrical equipment comprising the pivoting connection of the invention without an intermediate subsea connector.

In summary, a pivoting cable connection of the invention comprises a tubular cable guide supported by a subsea equipment unit. The cable guide extends along and around a pivot axis. A cable extending through the connection comprises an intermediate section extending along or beside the pivot axis within the cable guide and an outboard section, pivotable about the pivot axis, that extends away from the pivot axis in a direction transverse to the pivot axis. When installing or retrieving the unit onto or from the seabed, pivotal movement of the outboard section of the cable relative to the unit is accommodated by torsional deformation of the intermediate section of the cable.

By allowing the cable to pivot above and below the pivot axis, the connection enables the unit to be lowered from a vessel that also pays out and lays the cable. Preliminarily, the cable can be coupled to the unit aboard the same vessel. Only one vessel is therefore needed.

To put the invention into the context of the prior art, reference has already been made to FIGS. 1 to 4b of the accompanying drawings, in which:

FIG. 1 is a perspective view of a subsea transformer known in the prior art; and

FIGS. 2a to 4b are schematic side views that illustrate known techniques used to install subsea electrical equipment such as the transformer shown in FIG. 1.

In order that the invention may be more readily understood, reference will now be made, by way of example, to the remainder of the drawings in which:

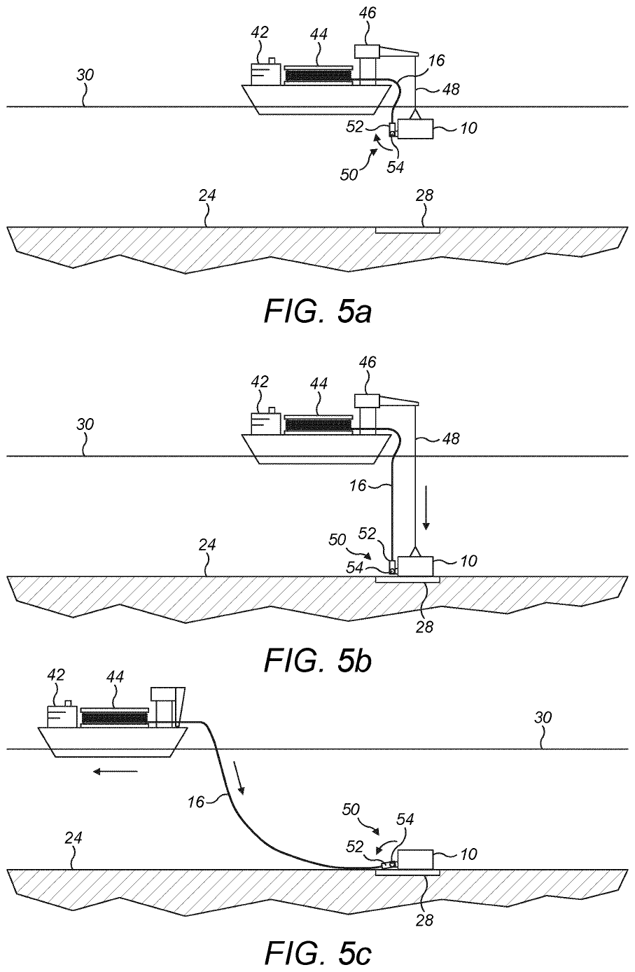

FIGS. 5a to 5c are a sequence of schematic side views that illustrate an installation method of the invention;

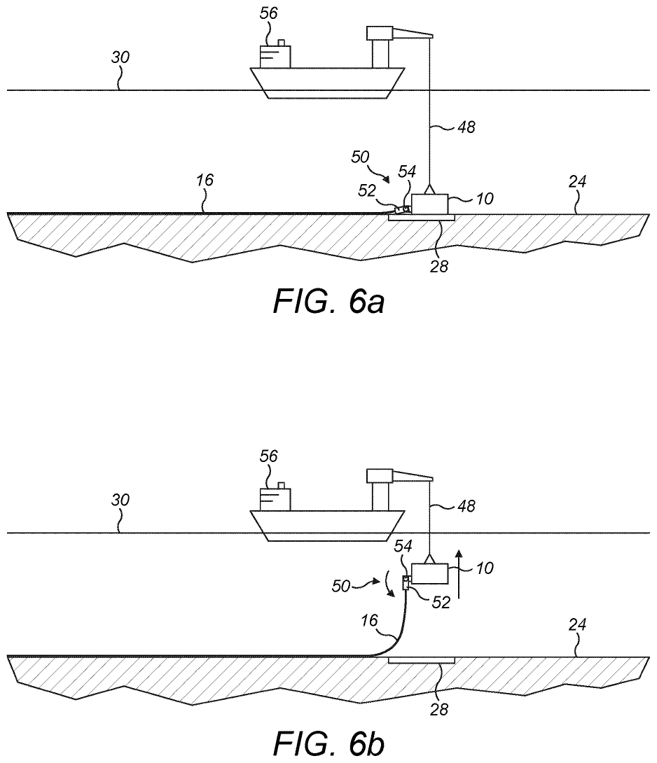

FIGS. 6a and 6b are a sequence of schematic side views that illustrate a retrieval method of the invention;

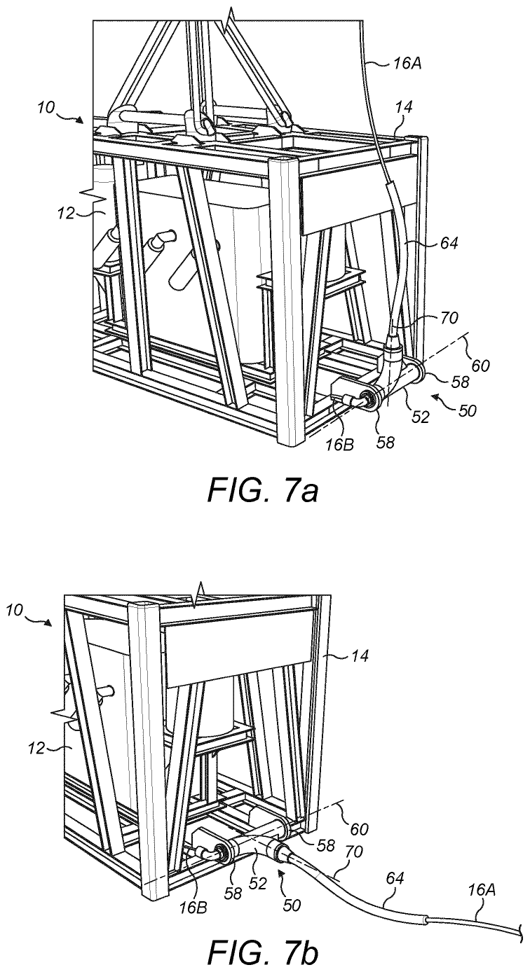

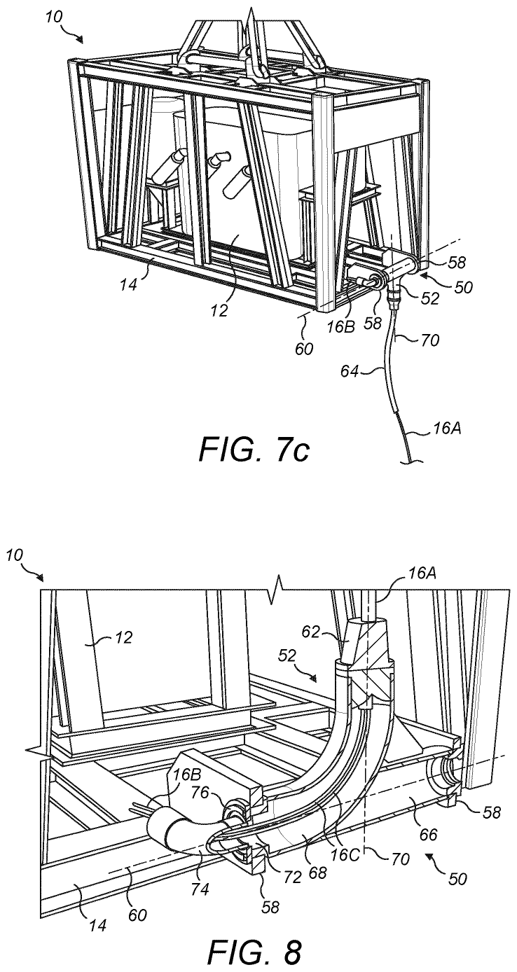

FIGS. 7a to 7c are perspective views of a first embodiment of the invention in installation, installed and retrieval states;

FIG. 8 is a cut-away perspective view of the first embodiment in the installation state shown in FIG. 7a;

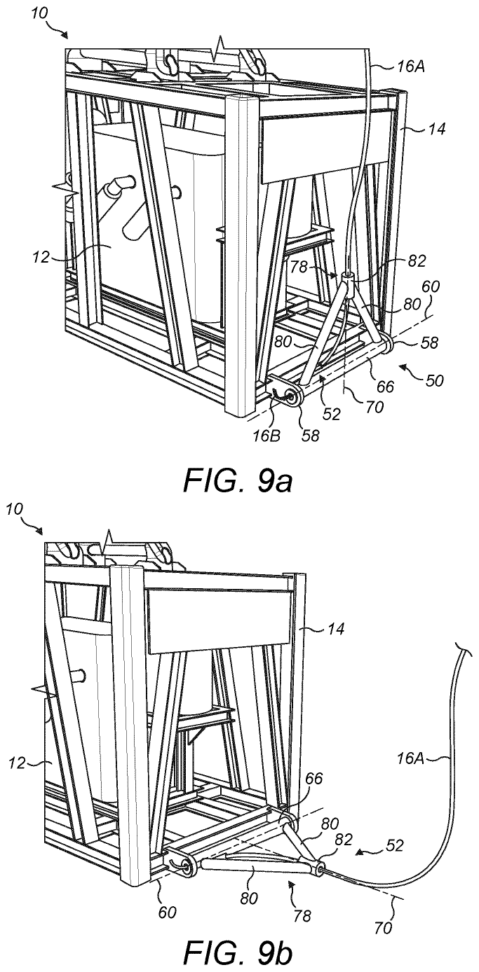

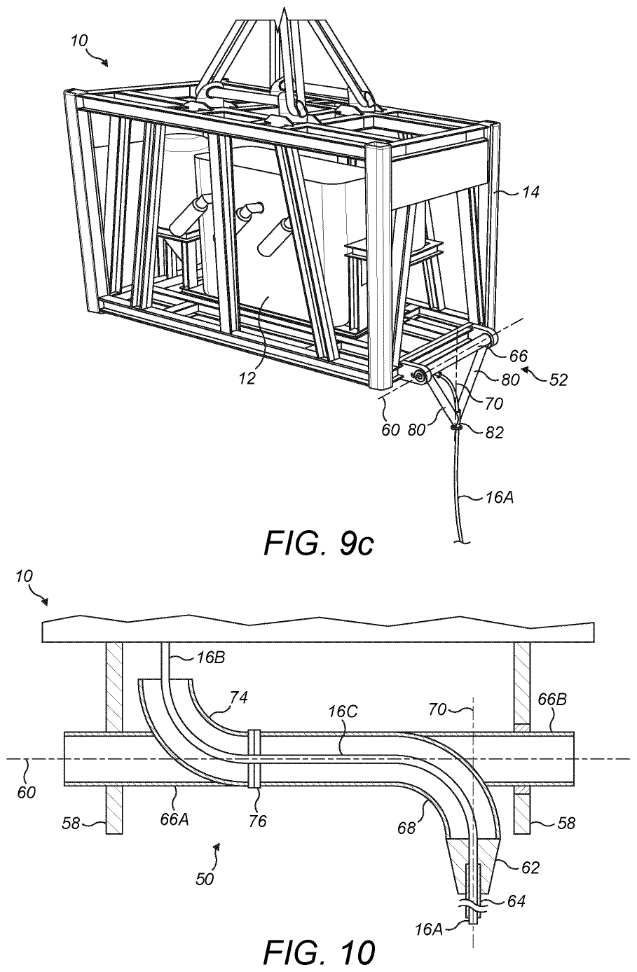

FIGS. 9a to 9c are perspective views of a second embodiment of the invention in installation, installed and retrieval states; and

FIGS. 10 to 12 are schematic top plan views of further embodiments of the invention.

Referring next, then, to FIGS. 5a to 5c of the drawings, an installation vessel 42 is shown stationed at the surface 30 above a subsea foundation 28 on the seabed 24. The vessel 42 is capable of carrying an item of subsea equipment, again exemplified here as a transformer unit 10, to be connected to a length of cable 16 that is stored aboard the vessel 42. For this purpose, the vessel 42 has a cable store 44 such as a carousel, as shown, or a reel. The vessel 42 also has a crane 46 for lifting the unit 10 into the sea suspended from a lifting line 48, as shown in FIG. 5a, after the cable 16 has been connected to the unit 10 aboard the vessel 42. The unit 10 remains in a substantially horizontal orientation throughout.

During installation, the cable 16 launched from the vessel 42 and the lifting line 48 extending from the crane 46 of the vessel 42 will remain in proximity. Consequently, on its path through the water column, the cable 16 adopts an upright orientation extending generally parallel to the lifting line 48 as shown in FIG. 5a.

In accordance with the invention, the upright orientation of the cable 16 at its interface with the horizontal unit 10 is accommodated by a pivoting connection 50 between the cable 16 and the unit 10. For this purpose, the connection 50 comprises an outer part or yoke 52 that is fixed to an inner portion of the cable 16 adjoining the unit 10 and that is coupled to the unit 10 via a pivot 54. This defines a flexible connection between the cable 16 and the unit 10.

The pivot 54 defines a horizontal pivot axis about which the yoke 52 extending away from that axis can pivot relative to the unit 10. More generally, the pivot axis is transverse to, or substantially orthogonal to, the general path of the cable 16 extending between the unit 10 and the vessel 42.

During installation as shown in FIG. 5a, the yoke 52 and the inner portion of the cable 16 lie in an installation state on a substantially vertical axis extending upwardly from the pivot 54, hence equivalent to a twelve o'clock (12:00) orientation about the pivot axis. The yoke 52 and the inner portion of the cable 16 retain that orientation until the unit 10 is landed on the foundation 28 as shown in FIG. 5b.

Next, as shown in FIG. 5c, the vessel 42 begins to travel across the surface 30 while launching more of the cable 16 to be laid on the seabed 24 along a lay path extending away from the unit 10. In consequence, the orientation of the yoke 52 and the inner portion of the cable 16 swings away from the vertical toward the horizontal, that being equivalent to a 9:00 orientation about the pivot axis.

Eventually, as in this example, the yoke 52 and the inner portion of the cable 16 can drop below the horizontal as shown in FIG. 5c. This allows upward inclination of the cable 16 approaching the unit 10 to accommodate any elevation of the pivot 54 above the seabed 24 that surrounds the unit 10. For example, the yoke 52 can adopt an orientation equivalent to about 8:00 or 7:30 about the pivot axis, the latter being about 45° to the vertical. The yoke 52 is then in an installed state.

Turning next to FIGS. 6a and 6b, these drawings show a further benefit of the pivoting connection 50 when a unit 10 is being retrieved to the surface 30 for replacement, maintenance or decommissioning.

FIG. 6a shows the unit 10 on the seabed 24 with the cable 16 extending away from the unit 10 across the seabed 24. The yoke 52 of the connection 50 retains the slight downward orientation from the final stage of installation as shown in FIG. 5c. A lifting line 48 has been attached to the unit 10, ready to lift the unit 10 and the attached end portion of the cable 16 to a maintenance vessel 56 at the surface 30.

When the unit 10 is lifted away from the seabed 24 as shown in FIG. 6b, the portion of cable 16 adjoining the unit 10 hangs with upright orientation beneath the pivot 54 of the connection 50. Consequently, the yoke 52 and the inner portion of the cable 16 are now in a retrieval state, oriented substantially vertically beneath the pivot 54 with an orientation equivalent to about 6:00 about the pivot axis.

The pivoting connection 50 shown schematically in FIGS. 5a to 6b can be implemented or embodied in various ways in accordance with the invention. Examples of such variants will now be described with reference to FIGS. 7a to 12.

In a first embodiment of a subsea equipment unit 10 of the invention shown in FIGS. 7a to 7c and FIG. 8, equipment such as a subsea transformer 12 is housed within a cuboidal lattice frame 14. An outrigger structure defined by mutually parallel upright supporting flanges 58 extends from an end of the frame 14 to support a pivoting connection 50. The pivoting connection 50 comprises a yoke 52 that can pivot with a cable 16 relative to the flanges 58 and the frame 14 about a substantially horizontal pivot axis 60.

FIGS. 7a, 7b and 8 show the unit 10 on the seabed. FIGS. 7a and 8 show the cable 16 and the yoke 52 extending upwardly in an installation state whereas FIG. 7b show the cable 16 and the yoke 52 extending laterally in an installed state. FIG. 7c shows the cable 16 and the yoke 52 extending downwardly in a retrieval state.

As best appreciated in FIG. 8, the cable 16 extending within and through the yoke 52 is fixed to the yoke 52 by a cable termination 62 serving as an anchor formation and is thereby anchored to the unit 10 via the yoke 52. FIGS. 7a to 7c show that an outboard section 16A of the cable 16 extending outwardly from the yoke 52 is surrounded by a bend limiter 64. The outboard section 16A extends in a direction away from but aligned with the unit 10. Ultimately, though not shown, the outboard section 16A is connected to a remote power source that provides electrical power to the transformer 12 or to a remote power consumer that receives electrical power from the transformer 12. Conversely, an inboard section 16B of the cable 16, only part of which is shown, extends inwardly from the yoke 52 to the transformer 12.

The yoke 52 comprises a tubular crossmember 66 that extends between and connects the flanges 58. A central longitudinal axis of the crossmember 66 coincides with the pivot axis 60. The crossmember 66 is pivotably mounted to the flanges 58 to turn about the pivot axis 60.

The yoke 52 further comprises a pipe bend 68 that intersects the crossmember 66 between the flanges 58 and extends through a side wall of the crossmember 66. Thus, the pipe bend 68 turns with the crossmember 66 about the pivot axis 60 in response to the local inclination of the cable 16. The pipe bend 68 curves through substantially 90° of arc from an inner end centred on the pivot axis 60 to an outer end that is radially outboard of the crossmember 66 and is centred on an exit axis 70 orthogonal to the pivot axis 60. The pipe bend 68 serves as a guide for the cable 16 and the outer end of the pipe bend 68 holds the cable termination 62 that supports the cable 16. The crossmember 66 and the pipe bend 68 may be of common diameter as shown, for example being formed of pipe with a diameter of fourteen inches (35.5 cm).

The inner end of the pipe bend 68 faces or adjoins an inner side of one of the flanges 58. An aperture 72 penetrating that flange 58 is centred on the pivot axis 60. Via that aperture 72, the pipe bend 68 communicates with an inner end of a curved tubular protective duct 74 that is fixed to an outer side of the flange 58 and is also centred on the pivot axis 60. The flange 58 supports a swivel coupling 76 that accommodates movement of the crossmember 66 and the pipe bend 68 about the pivot axis 60 relative to the fixed duct 74.

Like the pipe bend 68, the duct 74 curves through substantially 90° of arc but in this instance lies fixed in a generally horizontal plane, terminating in an outer end that faces toward the transformer 12. The duct 74 may be of smaller diameter than the pipe bend 68, for example being formed of pipe with a diameter of six inches (15.2 cm).

Together, the pipe bend 68 and the duct 74 communicating end-to-end define a path for the cable 16 extending through the pivoting connection 50. A transverse central portion of the cable 16 extends along or beside the pivot axis 60. That transverse portion of the cable 16 accommodates pivotal movement of the pivoting connection 50 relative to the unit 10.

The cable 16 is not necessarily uniform along its length, especially where the cable 16 extends through the yoke 52. For example, the cable 16 may comprise a longitudinal series of different sections, including an intermediate section 16C between the outboard and inboard sections 16A, 16B that defines the transverse portion of the cable 16.

The intermediate section 16C of the cable 16 is configured to accommodate pivoting of the yoke 52 about the pivot axis 60. For example, the intermediate section 16C could comprise a single element or cross section that twists about its longitudinal axis to accommodate pivotal movement of the yoke 52. This solution is possible if there is an acceptably low risk of failure of the cable 16 due to radial separation of its longitudinal elements under torsion-known in the art as ‘birdcaging’.

In this example, to reduce the possibility of birdcaging, the intermediate section 16C of the cable 16 comprises separate conductors grouped as strands or pigtails that extend generally parallel to each other along or beside the pivot axis 60 as shown in FIG. 8. The pigtails of the intermediate section 16C can deflect independently of each other and therefore accommodate pivotal movement of the yoke 52 about the pivot axis 60 mainly by bending along their length, without plastic deformation, rather than by twisting about their respective axes. Nevertheless, whilst the pigtails bend along their length, the intermediate section 16C still deforms torsionally when considered as a whole. Optionally, the pigtails extend through the duct 74 into the inboard section 16B of the cable 16 as shown.

Moving on now to FIGS. 9a to 9c, these drawings show a second embodiment of the invention in which like numerals are used for like features. Again, a subsea equipment unit 10 comprises equipment such as a subsea transformer 12 housed within a frame 14. A pivoting connection 50 is supported by an outrigger structure that extends from an end of the frame 14. The outrigger structure comprises upright flanges 58 supporting a yoke 52 that can pivot relative to the flanges 58. The yoke 52 comprises a horizontal tubular crossmember 66 that extends between and is pivotably mounted to the flanges 58 to turn about a substantially horizontal pivot axis 60.

In contrast to the pipe bend 68 of the first embodiment, the yoke 52 further comprises a cable support structure 78 that, in this example, comprises a pair of arms 80 that converge outwardly from the crossmember 66 to support a tubular collar 82 through which the cable 16 runs. The collar 82 is radially outboard of the crossmember 66 and is axially aligned with an exit axis 70 orthogonal to the pivot axis 60, disposed centrally between the flanges 58. The cable 16 could be anchored to the collar 82, for example with a cable termination 62 like that of the first embodiment or could be anchored elsewhere.

Inboard of the collar 82, the cable 16 bends laterally away from the exit axis 70. The cable 16 then enters the crossmember 66 through a side wall of the crossmember 66 inboard of one of the flanges 58. The cable 16 then follows or extends beside the pivot axis 60 within the crossmember 66 and extends through that flange 58 until an inboard section 16A emerges from an end of the crossmember 66 outboard of the flange 58.

As in the first embodiment, a bend limiter 64 on the outboard section of the cable 16A and a duct 74 on the inboard section 16B of the cable 16 are optional and have been omitted in this example. Similarly, an intermediate section of the cable 16 extending along or beside the pivot axis 60 may comprise two or more pigtails like those shown in FIG. 8. Alternatively, a cable 16 comprising a single element can be subjected to torsion about the pivot axis 60.

Many other variations are possible within the inventive concept. In this respect, reference is made finally to FIGS. 10 to 12 which show further embodiments to illustrate the breadth of the inventive concept. Again, like numerals are used for like parts.

In the pivoting connection 50 of FIG. 10, the duct 74 and the swivel coupling 76 are inboard of the flanges 58 that support the crossmember 66. To enable this arrangement, the crossmember 66 comprises a fixed portion 66A that is fixed to one of the flanges 58 and movable portion 66B that can pivot within the other flange 58. The fixed and movable portions 66A, 66B of the crossmember 66 are joined by the swivel coupling 76. The duct 74 curves from the fixed portion 66A and the pipe bend 68 curves from the movable portion 66B of the crossmember 66.

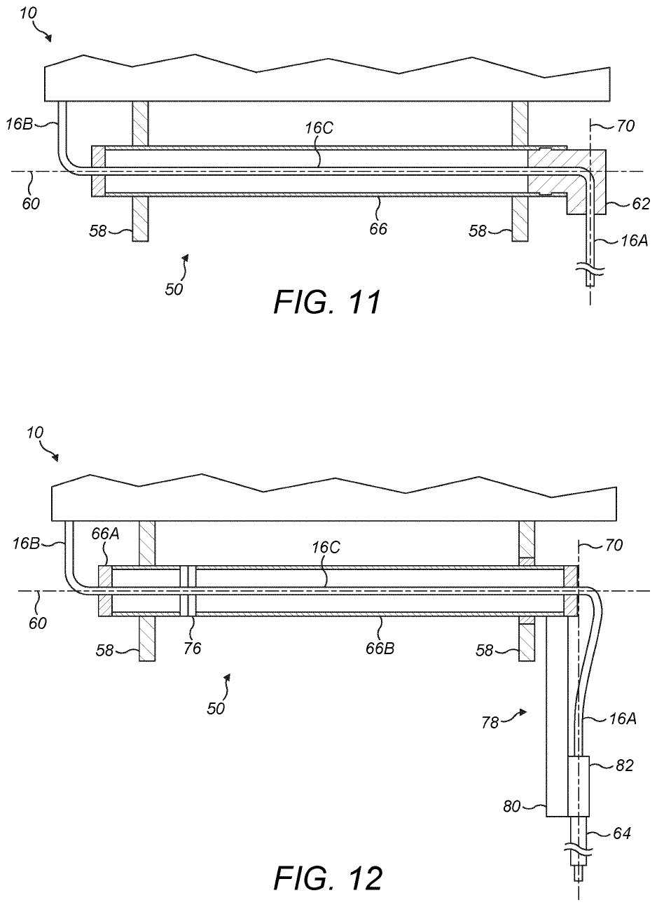

In the pivoting connection 50 of FIG. 11, the crossmember 66 is fixed relative to the frame 14 and the cable 16 extends along and through the crossmember 66, along or beside the pivot axis 60. In this example, the cable 16 is anchored to the crossmember 66 via a cable termination 62 that can pivot relative to the crossmember 66 but could be anchored differently or elsewhere.

In the pivoting connection 50 of FIG. 12, the crossmember 66 comprises a fixed portion 66A fixed to one of the flanges 58 and movable portion 66B that can pivot within the other flange 58. The fixed and movable portions 66A, 66B of the crossmember 66 are joined by the swivel coupling 76. In this example, the inboard section 16B of the cable 16 emerges from an outer end of the fixed portion 66A, outboard of the associated flange 58.

Similarly, the outboard section 16A of the cable 16 emerges from an outer end of the movable portion 66B, outboard of the associated flange 58. From there, the outboard section 16A of the cable 16 extends radially from the pivot axis 60 to a cable support structure 78, also outboard of the flange 58. In this example, the cable support structure 78 comprises an arm 80 fixed to the movable portion 66B of the crossmember 66. At its free end, the arm 80 supports a tubular collar 82 through which the outboard section 16A of the cable 16 runs. An optional bend limiter 64 extends from the collar 82 and surrounds the outboard section 16A.

In each of FIGS. 10 to 12, the intermediate portion 16C of the cable 16 extending along the crossmember 66 is shown as comprising a single torsional element but could instead comprise two or more pigtails like those shown in FIG. 8.

Among other variations, a locking mechanism may be provided to lock the yoke 52 against angular movement relative to the unit 10 or to limit such downward movement of the yoke 52 about the pivot 54 when in the installed state. The locking mechanism may then be released before retrieval of the unit 10 to allow the yoke 52 and the cable 16 to hang below the pivot 54 during retrieval.

A yoke 52 or other hinged support for the cable 16 could be attached to pivot formations such as trunnions disposed externally or internally relative to upright flanges. In the former case, the cable can exit a crossmember of the support outside the flanges whereas in the latter case, the cable can exit a crossmember of the support between the flanges. It would also be possible to mount a pivoting yoke 52 or other hinged support to the unit 10 in other ways, for example by attaching a yoke 52 to pivot points on members of the frame 14 of the unit 10. Thus, flanges are not essential to the broad concept of the invention.

1.-32. (canceled)

33. A subsea equipment unit comprising a pivoting cable connection, the connection comprising:
a cable guide supported by the unit for pivoting movement about a pivot axis, the cable guide extending along and around the pivot axis; and
a cable extending on a cable path through the connection, wherein the cable comprises:
an intermediate section at least partially within the cable guide, extending along or beside the pivot axis; and
an outboard section, pivotable about the pivot axis, extending away from the pivot axis in a direction transverse to the pivot axis.

34. The subsea equipment unit of claim 33, wherein the cable guide is tubular.

35. The subsea equipment unit of claim 33, wherein the cable guide forms part of a yoke that is pivotable about the pivot axis and that supports the outboard section of the cable at a location offset laterally from the pivot axis.

36. The subsea equipment unit of claim 35, further comprising an anchor formation that fixes the outboard section of the cable relative to the cable guide.

37. The subsea equipment unit of claim 35, wherein the outboard section of the cable curves away from the pivot axis contained within a portion of the cable guide that correspondingly curves away from the pivot axis.

38. The subsea equipment unit of claim 35, wherein the outboard section of the cable is supported by at least one arm extending from the cable guide.

39. The subsea equipment unit of claim 33, wherein the outboard section of the cable curves away from the pivot axis onto an exit axis that is substantially orthogonal to the pivot axis.

40. The subsea equipment unit of claim 33, wherein the outboard section of the cable curves away from the pivot axis in a plane containing the pivot axis.

41. The subsea equipment unit of claim 33, wherein the outboard section of the cable is aligned with the subsea equipment unit.

42. The subsea equipment unit of claim 33, wherein the pivot axis is substantially horizontal.

43. The subsea equipment unit of claim 33, wherein the intermediate section of the cable is disposed between the outboard section of the cable and an inboard section of the cable that extends transversely relative to the pivot axis away from the pivot axis and toward equipment of the unit.

44. The subsea equipment unit of claim 43, wherein the inboard section of the cable is in fixed relation to the unit.

45. The subsea equipment unit of claim 43, wherein the inboard section of the cable is received in a duct that communicates with the cable guide.

46. The subsea equipment unit of claim 45, wherein the duct and the inboard section of the cable together curve away from the pivot axis.

47. The subsea equipment unit of claim 45, wherein a swivel acting between the duct and the cable guide permits pivotal movement of the cable guide relative to the duct about the pivot axis.

48. The subsea equipment unit of claim 47, wherein the swivel surrounds an aperture in a support joining the connection to the subsea equipment unit and the duct communicates with the cable guide through the aperture.

49. The subsea equipment unit of claim 33, wherein the intermediate section of the cable is arranged to deform in torsion as the outboard section pivots about the pivot axis.

50. The subsea equipment unit of claim 49, wherein the intermediate section comprises two or more generally parallel strands arranged to bend along their length independently as the intermediate section deforms in torsion as a whole.

51. The subsea equipment unit of claim 33, wherein a pair of supports spaced along the pivot axis join the connection to the subsea equipment unit.

52. The subsea equipment unit of claim 51, wherein the cable curves away from the pivot axis between the supports of the pair.

53. The subsea equipment unit of claim 51, wherein the cable curves away from the pivot axis outboard of at least one of the supports of the pair.

54. A method of installing or retrieving a subsea equipment unit onto or from the seabed, the unit having a cable connected thereto, the cable having an intermediate section that is guided to extend along or beside a pivot axis, and an outboard section that extends transverse to the pivot axis, the method comprising:
causing the outboard section of the cable to pivot relative to the unit about the pivot axis; and
accommodating said pivotal movement by torsional deformation of the intermediate section of the cable.

55. The method of claim 54, comprising pivoting the outboard section of the cable about a substantially horizontal pivot axis.

56. The method of claim 55, comprising holding the outboard section of the cable in a substantially vertical orientation, above the pivot axis, when lowering the unit toward the seabed during installation.

57. The method of claim 56, comprising pivoting the outboard section of the cable into a substantially horizontal or below-horizontal orientation after landing the unit on the seabed.

58. The method of claim 57, comprising pivoting the outboard section of the cable into a substantially horizontal or below-horizontal orientation by laying the cable on the seabed in a lay direction extending away from the unit.

59. The method of claim 55, comprising allowing the outboard section of the cable to drop into a substantially vertical orientation, below the pivot axis, on lifting the unit from the seabed.

60. The method of any of claim 54, comprising locking the outboard section of the cable against said pivotal movement after installing the unit or unlocking the outboard section of the cable to permit said pivotal movement before retrieving the unit.

61. The method of any of claim 54, comprising installing the unit suspended from a vessel that also pays out the cable.

62. The method of claim 61, comprising using the same vessel to lay the cable after landing the unit on the seabed.

63. The method of claim 61, comprising preliminarily coupling the cable to the unit aboard the vessel.
